(19) United States
(12) Patent Application Publication
(10) Pub. No.: US 2009/0195209 A1
(43) Pub. Date: Aug. 6, 2009

(54) Radiation conversion device

(75) Inventors: Naoyuki Nishino, Minami-ashigara-shi (JP); Yasunori Ohta, Yokohama-shi (JP); Eiichi Kito, Minami-ashigara-shi (JP); Hiroshi Tamaoki, Odawara-shi (JP); Tatsuo Iiyama, Kanagawa-ken (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/320,581

(22) Filed: Jan. 29, 2009

(30) Foreign Application Priority Data
Jan. 31, 2008 (JP) 2008-020767

(51) Int. Cl. H02J 7/00

(52) U.S. Cl. 320/134

(57) ABSTRACT

A radiation conversion device, which is driven by an on-board battery, detects radiation that has passed through a subject and converts the radiation into image information. The radiation conversion device includes a battery residual charge amount detector for detecting a residual charge amount of the battery, a transmission rate setting unit for setting a transmission rate of the image information corresponding to the residual charge amount of the battery, and a transmitting unit for transmitting the image information to an external apparatus by means of wireless communications at the set transmission rate.

### BACKGROUND OF THE INVENTION

1. Field of the Invention

The present invention relates to a radiation conversion device, which is driven by an on-board battery mounted internally therein, for detecting radiation that has passed through the subject and converting the radiation into image information.

2. Description of the Related Art

In the medical field, a radiation image capturing apparatus, in which radiation is applied to a subject, and radiation that has passed through the subject is directed to a radiation conversion device for capturing a radiation image of the subject, has been widely used.

In this case, a radiation conversion device (electronic cassette) is disclosed, in which applied radiation is converted directly into electric signals, or after the radiation has been converted into visible light by a scintillator, a plurality of radiation detection elements made up from amorphous silicon or the like, and which are arranged in a matrix form, are used to convert the visible light into electric signals to enable reading thereof. (See, Japanese Laid-Open Patent Publication No. 2004-173907.)

In the aforementioned radiation conversion device, a transportable type of structure is known, which can be carried from place to place. Such a transportable type of radiation conversion device is connected to a wireless signal transmission module by a cable connected to the radiation conversion device, thereby enabling communications between the radiation conversion device and an external apparatus to be performed via the wireless signal transmission module.

Incidentally, when the information converted by the radiation conversion device has been transmitted to the external apparatus using the wireless signal transmission module, if during transmission the residual charge amount of the battery becomes too low, transmission errors could occur, which depends on the circumstances, may result in partial damage to the image information. In this case, recapturing of the radiation image by the radiation conversion device imposes a large burden on the patient (i.e., the subject whose image is to be captured).

### SUMMARY OF THE INVENTION

A general object of the present invention is to provide a radiation conversion device, in which transmission errors caused by a low residual charge amount of the battery are avoided, so that image information can be reliably transmitted to an external device.

A principal-object of the present invention is to provide a radiation conversion device, which can avoid damage to the image information during transmission thereof.

Another object of the present invention is to provide a radiation conversion device which can reliably transmit image information to an external device, thus making recapturing of the image unnecessary, and eliminating the burden on the subject whose image is being captured.

The radiation conversion device according to the present invention is characterized by a radiation conversion device, which is driven by an on-board battery, for detecting radiation that has passed through the subject and converting the radiation into image information, wherein the radiation conversion device includes a battery residual charge amount detector for detecting a residual charge amount of the battery, a transmission rate setting unit for setting a transmission rate of the image information corresponding to the residual charge amount of the battery, and a transmitting unit for transmitting the image information to an external apparatus by means of wireless communications at the set transmission rate.

According to the present invention, the transmission rate of the image information is set to a transmission rate that enables transmission corresponding to the residual charge amount of the battery of the radiation conversion device. By transmitting the image information wirelessly to an external apparatus at the thus set transmission rate, transmission errors due to a low residual charge amount of the battery can be avoided, so that appropriate image information can be transmitted to the external apparatus.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an explanatory view of a radiation image capturing system according to an embodiment of the present invention;

FIG. 2 is an internal structural view of an electronic cassette;

FIG. 3 is a schematic block diagram of the circuit structure of a radiation conversion panel making up the electronic cassette;

FIG. 4 is a schematic block diagram of the radiation image capturing system; and

FIG. 5 is a flowchart of a transmission process of radiation image information corresponding to the residual charge amount of the battery.

### DESCRIPTION OF THE PREFERRED EMBODIMENTS

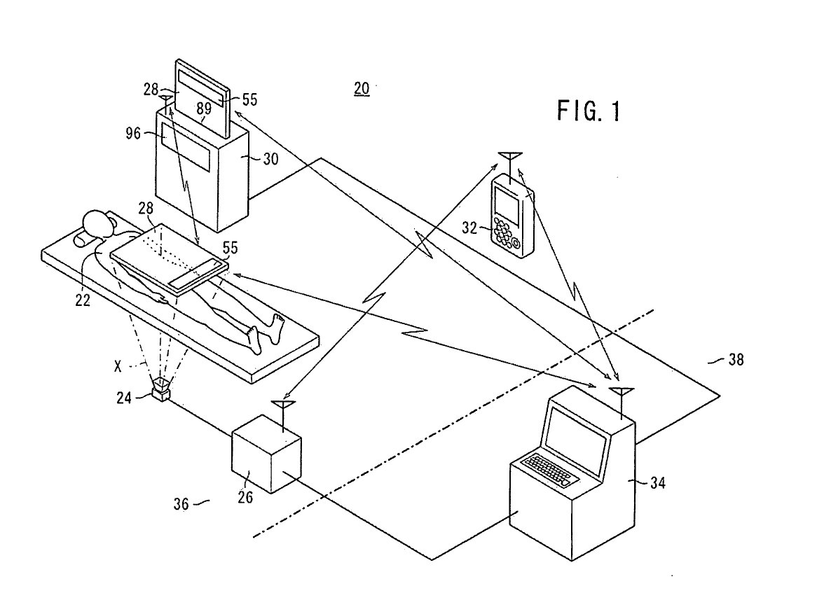

FIG. 1 is an explanatory view showing a radiation image capturing system 20 to which the radiation conversion device of the present invention is applied. The radiation image capturing system 20 is equipped with a radiation source 24 for irradiating a patient 22 (subject) with radiation X having a given dose according to image capturing conditions, a radiation source control device 26 for controlling the radiation source 24, an electronic cassette 28 (radiation conversion device) for converting the radiation X that has passed through the patient 22 into radiation image information, a cradle 30 for carrying out the electronic cassette 28 charging process and a display process for displaying the patient information, image capturing conditions, the radiation image information, and the like, a portable information terminal 32 having an image capturing switch for the radiation source 24, and which is carried by a technician for confirming conditions including image capturing operations, and a console 34, by which the radiation source control device 26, the electronic cassette 28, the cradle 30, and the portable information terminal 32 are controlled, while also transmitting and receiving necessary information therebetween.

The patient information is defined as information for specifying a patient 22, such as the name and sex of the patient 22, a patient ID number, and the like. The image capturing conditions are conditions for determining a tube voltage, a tube current, irradiation time, etc., for irradiating an imaging region of the patient 22 with an appropriate dose of radiation X. For example, the image capturing conditions may include the imaging region, the image capturing method, and the like. The patient information and the image capturing information can be obtained from the console 34.

The radiation source 24, the radiation source control device 26 and the cradle 30 are arranged inside of an image capturing room 36 where the image is to be captured, whereas the console 34 is disposed in an operations room 38 outside of the image capturing room 36. Further, wireless transmission of necessary information is transmitted and received between the radiation source control device 26 and the portable information terminal 32, between the portable information terminal 32 and the console 34, between the electronic cassette 28 and the console 34, and between the electronic cassette 28 and the cradle 30.

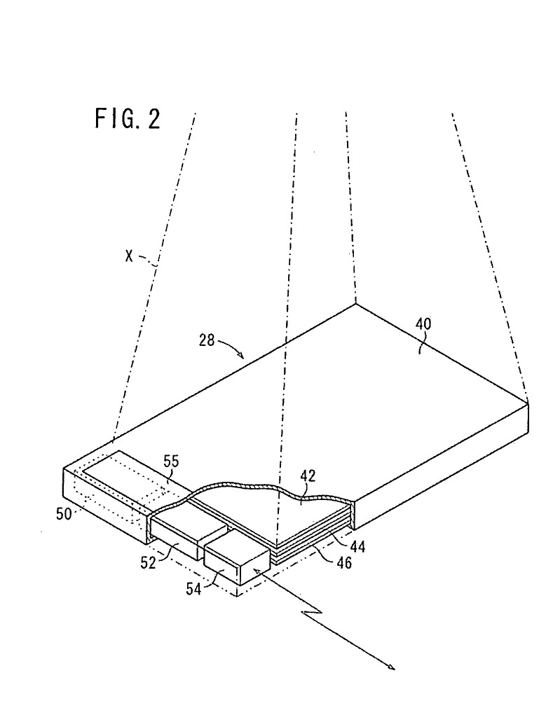

FIG. 2 is an internal structural view of the electronic cassette 28. The electronic cassette 28 is equipped with a casing 40 made from a material which is permeable to radiation X. Inside of the casing 40, from the side on which radiation X is irradiated, a grid 42 for removing scattered radiation X from the patient 22, a radiation conversion panel 44 for detecting radiation X that has passed through the patient 22, and a lead plate 46 for absorbing backscattered radiation X are arranged in this order.

A battery 50 which serves as a power source for the electronic cassette 28, a controller 52 that controls driving of the radiation conversion panel 44 based on the power supplied from the battery 50, and a transceiver (signal transmitting/receiving unit) 54 for wirelessly transmitting signals to the cradle 30 including radiation image information converted into electrical signals from radiation X by the radiation conversion panel 44, are accommodated inside the casing 40. Moreover, in the controller 52 and the transceiver 54, for avoiding damage caused by radiation X, it is preferable for a lead plate or the like to be disposed on surface sides of the casing 40 that are subject to being irradiated with radiation X.

Further, on a surface of the casing 40 corresponding to a region where the battery 50, the controller 52 and the transceiver 54 are arranged, a display unit 55 is disposed, which displays image capturing conditions and patient information of the patient 22 whose image is to be captured by the electronic cassette 28, together with other information, including the residual charge amount of the battery 50 that drives the electronic cassette 28, and transmission information of the radiation image information.

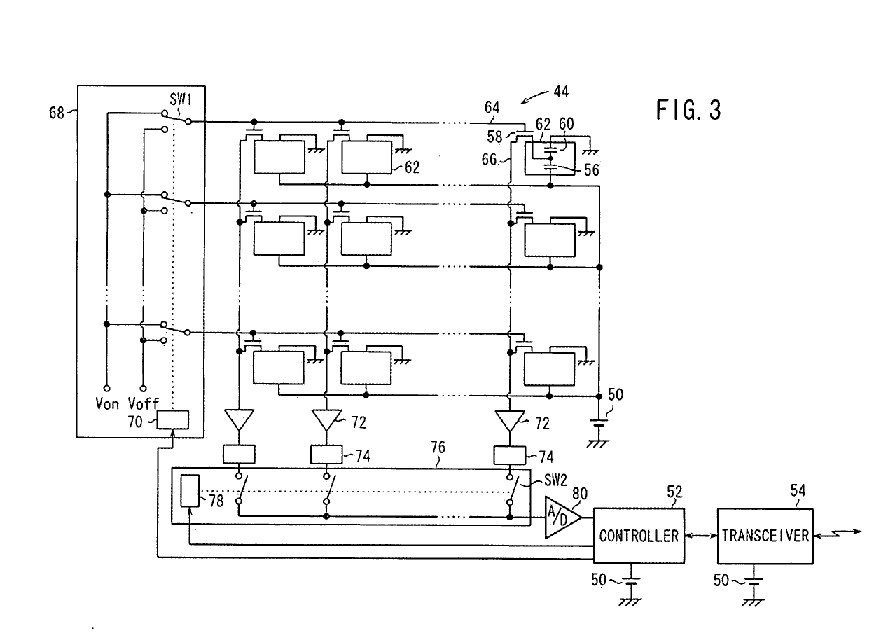

FIG. 3 is a block diagram of a circuit configuration of the electronic cassette 28 including the radiation conversion panel 44 therein. The radiation conversion panel 44 includes a structure in which a photoelectric conversion layer 56 made up from an amorphous selenium (a-Se) material or the like, which generates electric charges upon sensing radiation X, is disposed over thin film transistors (TFTs) 58 arrayed in a matrix form. After the generated electric charges are accumulated in storage capacitors 60, the TFTs 58 are successively turned on one line at a time, and the electric charges are read out as image signals. FIG. 3 shows the connected relationship of only one of the TFTs 58 and one pixel (image element) 62 made up from a photoelectric conversion layer 56 and a storage capacitor 60, whereas the structures of other similar pixels 62 have been omitted from illustration for clarity. Since the structure of amorphous selenium changes and the functionality thereof is lowered at high temperatures, amorphous selenium must be used within a prescribed temperature range. Accordingly, it is preferable to provide some means for cooling the radiation conversion panel 44 inside the electronic cassette 28.

Gate lines 64, which extend in parallel to the direction of the rows, and signal lines 66 which extend in parallel to the direction of the columns, are connected to the TFTs 58, which are connected respectively to each of the pixels 62. Each of the gate lines 64 is connected to a line scanning driver 68, and each of the signal lines 66 is connected to a multiplexer 76 that constitutes a reading circuit.

Control signals Von, Voff that control ON and OFF states of the TFTs 58 arrayed in the direction of the rows, are supplied from the line scanning driver 68 to the gate lines 64. In this case, the line scanning driver 68 comprises a plurality of switches SW1 that switch the gate lines 64 on or off, and an address decoder 70, which outputs a selection signal for selecting one of the switches SW1. Address signals are supplied from the controller 52 to the address decoder 70.

Further, the signal lines 66 are supplied with electric charges, which are stored in the storage capacitors 60 of each of the pixels 62, through the TFTs 58 arranged in the columns. The electric charges supplied to the signal lines 66 are amplified by amplifiers 72. The amplifiers 72 are connected through respective sample and hold circuits 74 to the multiplexer 76. The multiplexer 76 comprises a plurality of switches SW2 for successively switching between the signal lines 66, and an address decoder 78 for outputting a selection signal for selecting one of the switches SW2. The address decoder 78 is supplied with an address signal from the controller 52. An A/D converter 80 is connected to the multiplexer 76. A radiation image signal is converted by the A/D converter 80 into a digital image signal representing the radiation image information, which is supplied to the controller 52.

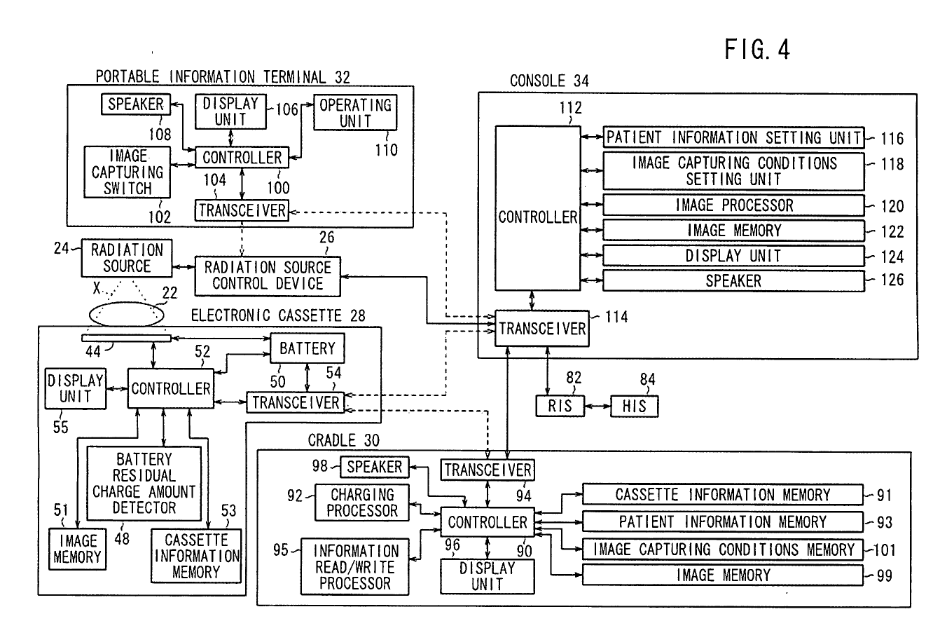

FIG. 4 is a schematic block diagram of the radiation image capturing system 20.

The radiation conversion panel 44, an image memory 51 for storing radiation image information detected by the radiation conversion panel 44, a cassette information memory 53 for storing cassette information comprising information specific to the electronic cassette 28, a display unit 55 for displaying cassette information, a transceiver 54, a battery 50 that supplies power to the electronic cassette 28, and a battery residual charge amount detector 48 for detecting a residual charge amount of the battery 50, are connected respectively to the controller 52 of the electronic cassette 28.

The controller 52 functions as a transmission rate setting unit, for setting a transmission rate for the radiation image information that is capable of being transmitted wirelessly to the console 34, in accordance with the detected residual charge amount of the battery 50. Further, the transceiver 54 functions as a charging detection unit for detecting whether the electronic cassette 28 is loaded into the cradle 30 and is currently undergoing charging. Furthermore, the controller 52 also functions as a power interruption controller, for interrupting the supply of electrical power from the battery 50 with respect to a portion of the image memory 51 from which the radiation image information has been read out.

Herein, the cassette information can be defined to include, for example, information concerning the residual charge amount of the battery 50, patient information associated with radiation image information that is stored in the image memory 51, transmission information of the radiation image information and the like. The patient information can be accessed and taken in from the cradle 30 or the console 34.

To the controller 90 of the cradle 30, there are connected respectively, a charging processor 92 that carries out a charging process on the battery 50 of the electronic cassette 28 loaded into a loading unit 89 (see FIG. 1), a cassette information memory 91 for storing cassette information obtained from the electronic cassette 28, an image memory 99 for storing the radiation image information acquired from the electronic cassette 28, a patient information memory 93 and an image capturing conditions memory 101 that store therein patient information and image capturing conditions obtained from the console 34, respectively, an information read/write processor 95 that writes in patient information and image capturing conditions to the electronic cassette 28 and also reads out cassette information and radiation image information from the electronic cassette 28, a display unit 96 for displaying necessary information including patient information, image capturing conditions and the acquired radiation image information, a speaker 98 for notifying a technician or the like concerning required information, and a transceiver (signal transmitting/receiving unit) 94 for carrying out transmission and reception of information between the electronic cassette 28 and the console 34. On the one hand, the transceiver 94 performs transmission and reception of signals with the electronic cassette 28 by means of wireless communications, while also performing transmission and reception of signals over wires with the console 34. Further, the charging process carried out with respect to the battery 50 of the electronic cassette 28 can be performed in a non-contact state through the transceiver 94, or in a contact state through a non-illustrated connector provided on the electronic cassette 28 loaded into the cradle 30.

A controller 100 of the portable information terminal 32 supplies an image capturing signal generated by an image capturing switch 102 that drives the radiation source 24 to the radiation source control device 26 through a transceiver (signal transmitting/receiving unit) 104. Further, the controller 100 displays on a display unit 106 patient information, imaging capturing conditions, and the like, which are received from the console 34 through the transceiver 104, and also carries out processing for notifying a technician or the like by causing necessary information to be emitted from a speaker 108. The portable information terminal 32 includes an operating unit 110 by which necessary information can be set therein.

The console 34 is equipped with a controller 112, a transceiver (signal transmitting/receiving unit) 114 for transmitting and receiving necessary information via wireless and/or wired communications with respect to the radiation source control device 26, the electronic cassette 28, the cradle 30 and the portable information terminal 32, a patient information setting unit 116 for setting patient information, an image capturing conditions setting unit 118 for setting required image capturing conditions for an image to be captured by the radiation source control device 26, an image processor 120 for performing image processing on the radiation image information, which is transmitted wirelessly from the electronic cassette 28 or supplied over wires from the electronic cassette 28 via the cradle 30, an image memory 122 for storing the processed radiation image information, a display unit 124 for displaying radiation image information and other necessary information, and a speaker 126 for notifying a technician or the like concerning the necessary information.

The console 34 is connected to a radiology information system (RIS) 82, which generally manages radiation image information handled by the radiological department of a hospital along with other information. The RIS 82 is connected to a hospital information system (HIS) 84, which generally manages medical information in the hospital. Image capturing order information, including the patient information and the image capturing conditions, may be set directly by the console 34, or alternatively, can be supplied to the console 34 from an external device via the RIS 82.

The radiation image capturing system 20 according to the present embodiment is constructed basically as described above. Next, explanations shall be made concerning operations of the radiation image capturing system 20.

When a radiation image of the patient 22 is to be captured, by using the patient information setting unit 116 of the console 34, patient information concerning the patient 22 is set, together with required image capturing conditions by using the image capturing conditions setting unit 118. Such information may be obtained from the RIS 82 and the HIS 84 from an upstream location via the transceiver 114. The thus set patient information and image capturing conditions can be displayed for confirmation on the display unit 124.

Next, the set patient information and image capturing conditions are transmitted from the transceiver 114 to the cradle 30, which is arranged inside the image capturing room 36, and the information and the conditions are displayed on the display unit 96 of the cradle 30 by the controller 90. In this case, the technician confirms the name of the patient 22, etc., whose image is to be captured, according to the patient information displayed on the display unit 96. By means of this confirmation process, accidents such as capturing an image by mistake of the wrong patient can be prevented from occurring. Further, according to the displayed image capturing conditions, the technician can confirm the imaging location, the image capturing method, etc.

On the other hand, the electronic cassette 28 used for capturing images is loaded into the cradle 30, and a charging process on the battery 50 is carried out by the charging processor 92. The information read/write processor 95 transmits patient information concerning the patient 22 whose image is being captured, together with the image capturing conditions, to the electronic cassette 28 via the transceiver 94. The controller 52 of the electronic cassette 28 stores the transmitted patient information and image capturing conditions in the cassette information memory 53, and displays the information and the conditions on the display unit 55. The display unit 55, as will be mentioned later, also can display the residual charge amount of the battery 50 of the electronic cassette 28, as well as transmission information of the radiation image information.

Further, the patient information and the image capturing conditions are transmitted from the transceiver 114 of the console 34 to the portable information terminal 32, which is carried by the technician, by means of wireless communications, and the information and the conditions are displayed on the display unit 106. In this case, the technician can confirm the patient information and the image capturing conditions that are displayed on the display unit 106 of the portable information terminal 32, so that desired preparations for capturing the image can be carried out.

Furthermore, the image capturing conditions are transmitted to the radiation source control device 26. The radiation source control device 26 sets the tube voltage, the tube current, and the irradiation time, which make up transmitted image capturing conditions, in the radiation source 24, thus carrying out preparations for capturing an image.

The technician confirms the patient information, which is displayed on the display unit 96 of the cradle 30 or on the display unit 55 of the electronic cassette 28, and the charge state, etc., of the electronic cassette 28, and withdraws from the loading unit 89 of the cradle 30 a usable electronic cassette 28 in which the corresponding patient information has been set. According to the set image capturing conditions, the electronic cassette 28 is set on a desired imaging region of the patient 22.

After the electronic cassette 28 has been set in an appropriate condition with respect to the patient 22, the technician operates the image capturing switch 102 of the portable information terminal 32, whereupon capturing of the radiation image is carried out. When the image capturing switch 102 is operated, the controller 100 of the portable information terminal 32 transmits an image capturing initiation signal to the radiation source control device 26 via the transceiver 104. The radiation source control device 26 that has received the image capturing initiation signal controls the radiation source 24 according to the image capturing conditions supplied beforehand from the console 34, and thereby irradiates the patient 22 with radiation X.

Radiation X that has passed through the patient 22, after scattered rays have been removed by the grid 42 of the electronic cassette 28, irradiate the radiation conversion panel 44 and are converted into electric signals by the photoelectric conversion layer 56 of each of the pixels 62 making up the radiation conversion panel 44, which are retained as charges in the storage capacitors 60 (see FIG. 3). Next, the electric charge information that forms the radiation image information of the patient 22 stored in each of the storage capacitors 60 is read out in accordance with address signals, which are supplied from the controller 52 to the line scanning driver 68 and the multiplexer 76.

More specifically, the address decoder 70 of the line scanning driver 68 outputs a selection signal based on the address signal supplied from the controller 52, thereby selecting one of the switches SW1, and supplies a control signal Von to the gate of the TFT 58 that is connected to a corresponding gate line 64. On the other hand, the address decoder 78 of the multiplexer 76 outputs a selection signal according to the address signal supplied from the controller 52, and successively switches the switches SW2, whereby the radiation image information, which is formed as electric charge information stored in the storage capacitors 60 of each of the pixels (image elements) 62 that are connected to the gate line 64 selected by the line scanning driver 68, is read out in succession through the signal lines 66.

The radiation image information read from the storage capacitors 60 of each of the pixels 62 connected to the selected gate line 64 of the radiation conversion panel 44 is amplified by respective amplifiers 72, sampled by the sample and hold circuits 74, and is supplied to the A/D converter 80 through the multiplexer 76 and converted into digital signals. The radiation image information having been converted into digital signals is temporarily stored in the image memory 51 connected to the controller 52.

Similarly, the address decoder 70 of the line scanning driver 68 successively turns on the switches SW1 according to the address signals supplied from the controller 52, and reads out the radiation image information, which is made up of charge information stored in the storage capacitors 60 of each of the pixels 62 connected respectively to the gate lines 64 through the signal lines 66, whereupon the radiation image information is temporarily stored in the image memory 51 connected to the controller 52 through the multiplexer 76 and the A/D converter 80.

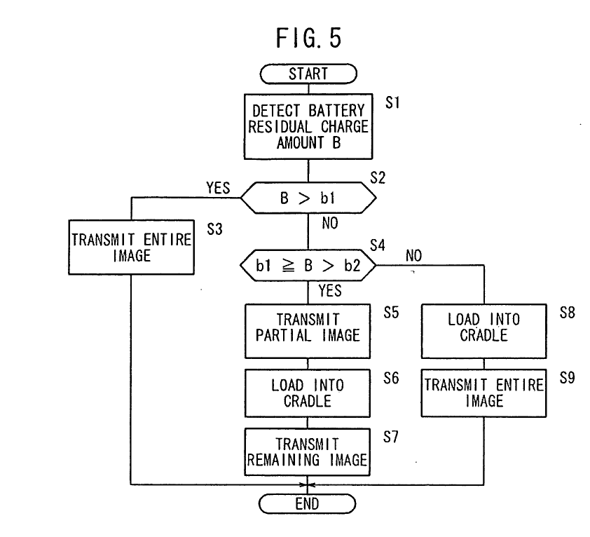

Upon completion of image capturing, the electronic cassette 28 in which radiation image information of the patient 22 has been recorded immediately begins a transmission process to the cradle 30 of the radiation image information stored in the image memory 51. Processing that is carried out in this case shall be explained in accordance with the flowchart shown in FIG. 5. In the following explanations, a situation is described in which the radiation image information is transmitted to the cradle 30. However, the invention also is applicable to situations in which the radiation image information is transmitted in a similar manner with respect to the portable information terminal 32 and the console 34.

At first, the controller 52 controls the battery residual charge amount detector 48 and detects a residual charge amount B of the battery 50 (step Si). Next, a total image transmittable charge amount b1, which is a preset threshold at which the total image made up of the radiation image information stored in the image memory 51 can be transmitted wirelessly, is compared with the current residual charge amount B detected by the battery residual charge amount detector 48. In the event that B>b1 (step S2), the transceiver 54 is driven and the total image consisting of the radiation image information is transmitted by wireless communications to the cradle 30 (step S3) by using power supplied from the battery 50.

The controller 90 of the cradle 30 causes the transmitted radiation image information to be stored in the image memory 99. Further, the controller 90 reads out the radiation image information from the image memory 99 and displays the information as a preview image on the display unit 96. The technician can judge whether or not the image capturing conditions are appropriate based on the displayed preview image. In this case, so long as the preview image enables one to confirm that the imaging conditions are appropriate, the preview image can be displayed as an image in which the number of image elements (pixels) is reduced, for example, as an image formed by thinning out the radiation image information read out from the image memory 99, an image formed by subjecting the radiation image information to compression processing, an image formed by subjecting the radiation image information to interpolation processing, an image formed by cutting out a portion of the radiation image information, or as an image that is formed based on an averaged value of the radiation image information, or the like. In this manner, by performing such a process to reduce the number of image elements, the time required to display the image can be shortened.

Moreover, the residual charge amount of the battery 50 as detected by the battery residual charge amount detector 48 can be displayed on the display unit 55 of the electronic cassette 28, together with transmission information, which indicates that a total image made up from the radiation image information is transmitted to the cradle 30.

On the other hand, in the event that the current residual charge amount B of the battery 50 is less than or equal to b1 (B≦b1) (step S2), a partial image transmitting residual charge amount b2, which is a preset threshold that enables a portion of the image made up from the radiation image information to be transmitted wirelessly, is compared with the current residual charge amount B. If the condition b1≧B>b2 holds true (step S4), the transceiver 54 is driven, and a portion of the image made up of the radiation image information is transmitted to the cradle 30 using the residual charge amount B of the battery 50 (step S5).

In this case, it is sufficient if the image information transmitted to the cradle 30 is capable of being displayed as a preview image. Accordingly, corresponding to the partial image transmittable residual charge amount b2, the controller 52 may transmit to the cradle 30 radiation image information in which a portion of the radiation image information read out from the image memory 51 is thinned out, radiation image information subjected to compression processing, radiation image information subjected to interpolation processing by spline processing or the like, radiation image information formed by cutting out a portion while still enabling confirmation of the image, or radiation image information in which the number of image elements (pixels) thereof is reduced on average, or the like.

In the electronic cassette 28, for which a portion of the radiation image information has been transmitted to the cradle 30, for example, in the case that radiation image information subjected to thinning out processing has been transmitted to the cradle 30, since there is no need to retain the transmitted radiation image information in the electronic cassette 28, the supply of power from the battery 50 with respect to a portion of the image memory 51 retaining such radiation image information is suspended, thereby avoiding needless consumption of power from the battery 50.

In the cradle 30, which has received a portion of the radiation image information, after such radiation image information has been stored in the image memory 99, the information is displayed on the display unit 96 as a preview image. In this case, a sufficient preview image for enabling confirmation of the image capturing conditions can be displayed immediately on the display unit 96.

On the other hand, after the portion of the radiation image information has been transmitted to the cradle 30, the electronic cassette 28 is loaded into the cradle 30 (step S6), which is arranged in the image capturing room 36 where the image is captured. The residual charge amount B of the battery 50, together with display information indicating that a partial image from the radiation image information has been transmitted to the cradle 30, can be displayed on the display unit 55 of the electronic cassette 28.

In the electronic cassette 28, which has been loaded into the cradle 30, a charging process is carried out on the battery 50 by the charging processor 92. When it is detected that the battery 50 is undergoing charging, the transceiver 54 transmits the remaining portion of the radiation image information stored in the image memory 51 to the cradle 30 via wireless communications (step S7), utilizing power supplied thereto from the cradle 30 or power supplied from the battery 50 while the battery undergoes charging. The cradle 30 causes newly received remaining portion of radiation image information, as well as previously transmitted radiation image information, to be stored in the image memory 99.

The electronic cassette 28 may also transmit the entire radiation image information to the cradle 30, and not simply the remaining non-transmitted portion of the radiation image information that is stored in the image memory 51.

Next, the cradle 30 transmits the radiation image information stored in the image memory 99 to the console 34 by means of wired communications via the transceiver 94. The controller 112 of the console 34 stores the transmitted radiation image information in the image memory 122, and displays the information on the display unit 124. In this case, the displayed image may also be a preview image, or may be a detailed image utilizing the entirety of the radiation image information.

In the case that the current residual charge amount B of the battery 50 is in a state such that B≦b2 (step S4), the electronic cassette 28 is loaded into the cradle 30 prior to transmission of the radiation image information (step S8), and charging of the battery 50 is performed by the charging processor 92. The transceiver 54 detects that the battery 50 is currently undergoing charging, by using power supplied from the cradle 30 or the power supplied from the battery 50 while the battery undergoes charging, transmits the entire image made up from the radiation image information stored in the image memory 51 via wireless communications to the cradle 30 (step S9).

By carrying out transmission processing of the radiation image information in the foregoing manner, irrespective of the residual charge amount of the battery 50 of the electronic cassette 28, a complete image made up of the radiation image information can be transmitted reliably to the cradle 30 and the console 34, in a condition in which transmission errors do not occur. At the console 34, predetermined image processing by the image processor 120 is implemented with respect to the radiation image information stored in the image memory 122, and the image is displayed on the display unit 124. In this case, the technician can confirm the radiation information displayed on the display unit 124, and can confirm whether or not a suitable image was captured with respect to a desired patient 22.

Further, as may be required, after compression processing has been implemented on the radiation image information, the radiation image information is transmitted from the transceiver 114 to the portable information terminal 32 held by the technician, so as to provide a preview image on the display unit 106. Further, a configuration can also be provided in which the radiation image information is transmitted directly to the portable information terminal 32 from the cradle 30 or the electronic cassette 28.

Of course, the present invention is not limited to the above-described embodiment, and the invention can be freely modified, within a range that does not deviate from the essence and gist of the present invention.

For example, the radiation conversion panel 44 accommodated in the electronic cassette 28 converts the radiation dose of the irradiated radiation X directly into electric signals through the photoelectric conversion layer 56. However, in place of this structure, a radiation conversion panel in which irradiated radiation X is converted initially into visible light by a scintillator, and thereafter, the visible light is converted into electric signals using a solid-state detector element formed from amorphous silicon (a-Si) or the like, may also be used (see, Japanese Patent No. 3494683).

Further, the radiation image information can be obtained using a light-conversion type of radiation conversion panel. With such a light-conversion type of radiation conversion panel, radiation is irradiated onto respective solid state detection elements arranged in a matrix form, and an electrostatic latent image corresponding to the radiation dose is stored cumulatively in the solid state detection elements. When the electrostatic latent image is read, reading light is irradiated onto the radiation conversion panel, and the generated current values are acquired as-radiation image information. Further, by irradiating the radiation conversion panel with erasing light, the radiation image information in the form of a residual electrostatic latent image can be erased and the radiation conversion panel can be reused (see, Japanese Laid-Open Patent Publication No. 2000-105297).

What is claimed is:

1. A radiation conversion device, which is driven by an on-board battery, for detecting radiation that has passed through a subject and converting the radiation into image information, comprising:
a battery residual charge amount detector for detecting a residual charge amount of the battery;
a transmission rate setting unit for setting a transmission rate of the image information corresponding to the residual charge amount of the battery; and
a transmitting unit for transmitting the image information to an external apparatus by means of wireless communications at the set transmission rate.

2. The radiation conversion device according to claim 1, further comprising a charging detection unit for detecting that the battery is undergoing charging, wherein when it is detected that the battery is undergoing charging, the transmitting unit transmits all of the image information or an untransmitted portion of the image information to the external apparatus.

3. The radiation conversion device according to claim 2, wherein the external apparatus comprises a charging cradle, which is connected to the radiation conversion device and charges the battery.

4. The radiation conversion device according to claim 1, wherein the transmission rate setting unit thins out the image information to image information that can be previewed by the external apparatus and sets the transmission rate, corresponding to the residual charge amount of the battery.

5. The radiation conversion device according to claim 1, wherein the transmission rate setting unit processes the image information into image information that can be previewed by the external apparatus and sets the transmission rate, corresponding to the residual charge amount of the battery.

6. The radiation conversion device according to claim 1, further comprising a display unit for displaying transmission information, which indicates that a total image or a partial image made up of the radiation image information is transmitted to the external apparatus.

7. The radiation conversion device according to claim 6, wherein the display unit displays the residual charge amount of the battery.

8. The radiation conversion device according to claim 1, further comprising:
an image memory for storing the image information; and
a power interruption controller for interrupting supply of power from the battery with respect to the image memory storing the image information that has been transmitted to the external apparatus.
